(19) United States
(12) Patent Application Publication
(10) Pub. No.: US 2026/0135411 A1
(43) Pub. Date: May 14, 2026

(54) POWER RECEIVER AND POWER TRANSFER SYSTEM

(71) Applicant: Murata Manufacturing Co., Ltd., Nagaokakyo-shi (JP)

(72) Inventors: Akihiro YAMAKAWA, Nagaokakyo-shi (JP); Noriaki OKUDA, Nagaokakyo-shi (JP)

(21) Appl. No.: 19/444,375

(22) Filed: Jan. 9, 2026

Related U.S. Application Data
(63) Continuation of application No. PCT/JP2024/029750, filed on Aug. 22, 2024.

(30) Foreign Application Priority Data
Sep. 11, 2023 (JP) 2023-146615

(51) Int. Cl. H02J 50/10; H01F 27/28; H01F 38/14; H02J 50/00; H02J 50/70

(52) U.S. Cl. CPC H02J 50/10; H01F 27/2885; H01F 38/14; H02J 50/005; H02J 50/70

(57) ABSTRACT

A power receiver includes a power-receiving coil holder extending along and in proximity to a power-feeding-side housing, and a power receiving coil located at the power-receiving coil holder. The power-receiving coil holder includes a planar portion, and a power-receiving-side rising portion that extends from a periphery of the planar portion and that has a directional component perpendicular or substantially perpendicular to the planar portion and a directional component aligned with the planar portion. The power receiving coil is located along the planar portion and the power-receiving-side rising portion.

### CROSS REFERENCE TO RELATED APPLICATIONS

This application claims the benefit of priority to Japanese Patent Application No. 2023-146615 filed on Sep. 11, 2023 and is a Continuation Application of PCT Application No. PCT/JP 2024/029750 filed on Aug. 22, 2024. The entire contents of each application are hereby incorporated herein by reference.

### BACKGROUND OF THE INVENTION

### 1. Field of the Invention

The present invention relates to power receivers each configured to receive electric power, and power transfer systems each including a power receiver.

### 2. Description of the Related Art

Wireless power transfer systems wirelessly transfer electric power from a power feeder to a power receiver when the power receiver is positioned in proximity to the power feeder. In such a wireless power transfer system, the respective power transfer units of a wireless power feeder and a wireless power receiver are coupled to each other via a magnetic field, an electric field, or an electromagnetic field.

In some cases, to position the respective power transfer units of the power feeder and the power receiver in proximity to each other as described above, a configuration may be used in which the power feeder is provided with a recess and the power receiver is disposed in the recess. For example, according to Japanese Unexamined Patent Application Publication 2010-062167, the housing of the power feeder includes a recess having a curved surface, the housing of the power receiver includes a projection having a curved surface, and during power transfer, the two curved surfaces are positioned to align with each other.

The power receiver in Japanese Unexamined Patent Application Publication 2010-062167 includes a power receiver housing, a power receiving coil, and a circuit board, which are separate components. The power receiving coil is connected to the circuit board of the power receiver via solder or other method. This configuration leads to a large resistance component at the connection between the power receiving coil and the circuit board of the power receiver, and consequently to resistance loss. Further, assembling the above-described components is cumbersome.

### SUMMARY OF THE INVENTION

Example embodiments of the present invention provide power receivers and power transfer systems each enabling coupling between a power feeding coil and a power receiving coil when a rising portion of a power feeder and a rising portion of a power receiver are positioned adjacent to each other, and that each provide improved power transfer efficiency and/or improved operating efficiency of individual components.

A power receiver according to an example embodiment of the present invention is configured to be positioned in proximity to a power feeder to receive electric power. The power feeder includes a power-feeding-side housing and a power feeding coil. The power-feeding-side housing includes a power-feeding-side rising portion. The power feeding coil is positioned at the power-feeding-side housing. The power receiver includes a power-receiving coil holder extending along and in proximity to the power-feeding-side housing, and a power receiving coil and a conductor other than the power receiving coil in the power-receiving coil holder or extending along a surface of the power-receiving coil holder. The power-receiving coil holder includes a planar portion, and a power-receiving-side rising portion extending from a periphery of the planar portion and along the power feeding-side rising portion. The power-receiving-side rising portion includes surfaces oriented in different directions. The power receiving coil is positioned along the planar portion and the power-receiving-side rising portion.

A power transfer system according to an example embodiment of the present invention includes a power receiver according to an example embodiment of the present invention and the power feeder.

Example embodiments of the present invention provide power receiver and power transfer systems each enabling coupling between a power feeding coil and a power receiving coil when a rising portion of a power feeder and a rising portion of a the power receiver are positioned adjacent to each other, and that each provide improved power transfer efficiency and/or improved operating efficiency of individual components.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a power receiver 201 according to a first example embodiment of the present invention.

FIG. 2 is a perspective view of a power-receiving coil device 23, showing an upper surface side where a coil on the surface of the power-receiving coil device 23 is visible.

FIG. 3 is a longitudinal sectional view of the power receiver 201 shown in FIG. 1.

FIG. 4 is a partially cutaway perspective view of a power transfer system 301 according to the first example embodiment of the present invention, which includes a power feeder 101 and the power receiver 201.

FIG. 5 illustrates, in a longitudinal cross section, the power receiver 201 and the power feeder 101 according to an example embodiment of the present invention.

FIG. 6 is a longitudinal sectional view of the power transfer system 301 according to an example embodiment of the present invention with the power receiver 201 provided on the power feeder 101.

FIG. 7 is a longitudinal sectional view of a power receiver 201A according to an example embodiment of the present invention.

FIG. 8 is a block diagram illustrating the configuration of various portions of the power transfer system according to the first example embodiment of the present invention.

FIG. 9 is a longitudinal sectional view of a power receiver 202 according to a second example embodiment of the present invention.

FIG. 10 is a front view of a power-receiving coil device 23 according to a third example embodiment of the present invention.

FIG. 11 is a front sectional view of the power-receiving coil device 23 according to the third example embodiment of the present invention.

FIG. 12 is a partially cutaway perspective view of a power transfer system 304 according to a fourth example embodiment of the present invention, which includes a power feeder 104 and a power receiver 204.

FIG. 13 is a partial front sectional view of the power receiver 204 according to the fourth example embodiment of the present invention.

FIG. 14 is a partially cutaway perspective view of a power receiver 204A according to the fourth example embodiment of the present invention.

FIG. 15 is a partial sectional perspective view of a power-receiving coil holder 22 of a power receiver according to a fifth example embodiment of the present invention.

FIG. 16 is a partial sectional perspective view of the power-receiving coil holder 22 of the power receiver according to the fifth example embodiment of the present invention.

FIG. 17 illustrates, in partial sectional perspective view and in partial front sectional view, a power-receiving coil holder 22 of a power receiver according to a sixth example embodiment of the present invention.

The upper portion of FIG. 18 is a longitudinal sectional view of a power receiver 205 according to a seventh example embodiment of the present invention. The lower portion of FIG. 18 is a perspective view of the power-receiving coil device 23 as seen from below.

FIG. 19 is a sectional view of the power receiver 205 that is being used as a biological sensor for a biological body HB.

FIG. 20 illustrates the power receiver 205 that is being worn on the left wrist of a human body.

### DETAILED DESCRIPTION OF THE EXAMPLE EMBODIMENTS

Example embodiments of the present invention are described below with reference to the drawings by explaining several example embodiments. Throughout the drawings, the same reference signs are used to designate the same or corresponding portions or features. Although separate example embodiments are herein described for convenience in consideration of the ease of explanation or understanding of the main scope of the present invention, features described in different example embodiments can be partially substituted for or combined with each other. In the second and subsequent example embodiments, matters or features the same or substantially the same as those of the first example embodiment are not described in further detail, and only differences from the first example embodiment are described. In particular, the same or similar advantageous effects provided by the same or similar features are not described for each individual example embodiment.

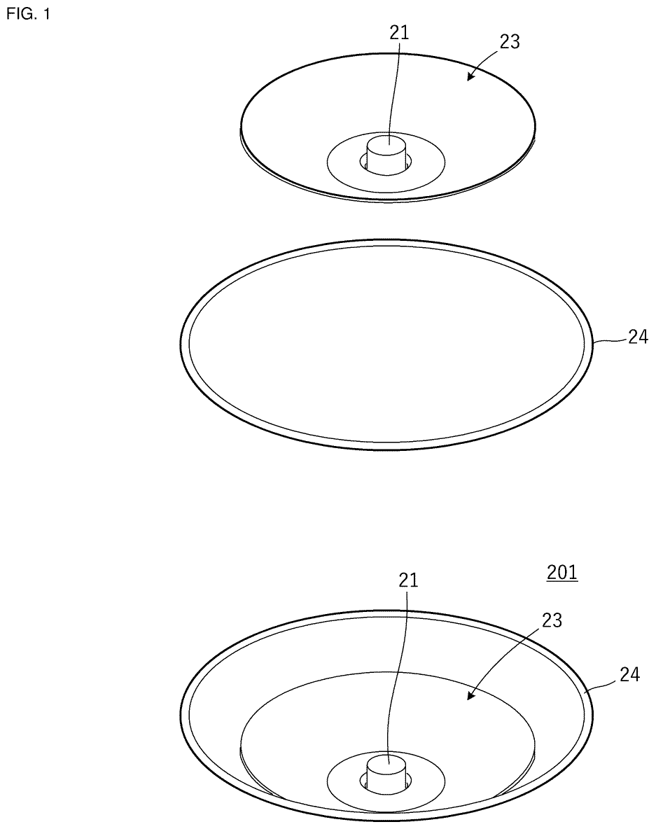

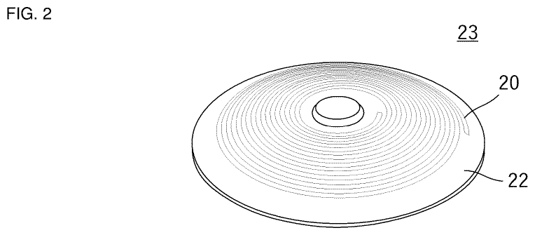

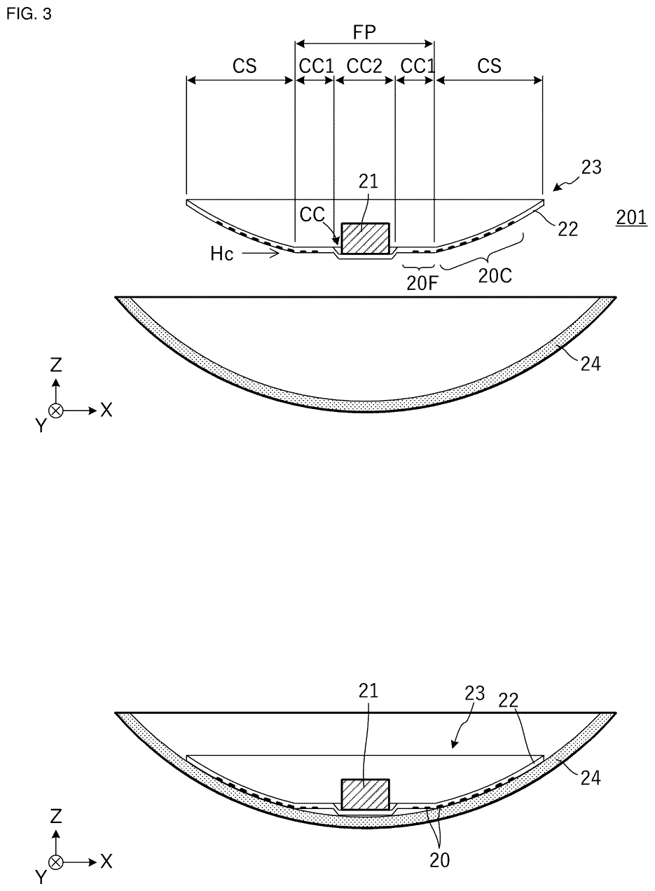

FIG. 1 is a perspective view of a power receiver 201 according to a first example embodiment of the present invention. The upper portion of FIG. 1 is an exploded perspective view of the power receiver 201, and the lower portion of FIG. 1 is a perspective view of the power receiver 201 in its assembled state. FIG. 2 is a perspective view of a power-receiving coil device 23, showing an upper surface side where a coil on the surface of the power-receiving coil device 23 is visible. FIG. 3 is a longitudinal sectional view of the power receiver 201.

As illustrated in FIG. 1, the power receiver 201 includes the power-receiving coil device 23 held by a power-receiving coil device holder 24.

The power receiver 201 includes the power-receiving coil device holder 24, and the power-receiving coil device 23 and a magnetic component 21 that are provided at the power-receiving coil device holder 24. The power receiver 201 includes components (not illustrated) other than those described above.

The power receiver 201 is a power receiver configured to be positioned in proximity to a power feeder to receive electric power. A description of how the power feeder is constructed, and a description of how the power receiver 201 is positioned in proximity to the power feeder will be provided later.

As illustrated in FIGS. 2 and 3, a power-receiving coil holder 22 includes a planar portion FP, and a power-receiving-side rising portion CS extending from the periphery of the planar portion FP and including surfaces that are oriented in different directions. According to the first example embodiment, the power-receiving-side rising portion CS extends from the periphery of the planar portion FP, and has a directional (Z-direction) component perpendicular or substantially perpendicular to the planar portion FP and a directional (X-direction) component aligned with the planar portion FP. In the present example embodiment, the planar portion FP includes therein a recess CC defined by a first planar portion CC1 and a second planar portion CC2. The first planar portion CC1 is located at a height Hc where the power-receiving-side rising portion CS and the planar portion FP are continuous with each other. The second planar portion CC2 is located at a lower height than the first planar portion CC1.

The magnetic component 21 is bonded on the top (within the recess CC) of the second planar portion CC2.

The power-receiving-side rising portion CS of the power-receiving coil holder 22 has a shape defining a band-shaped portion of a sphere (spherical shell) that has a predetermined thickness (a spherical band having a predetermined thickness). The power-receiving coil holder 22 is, for example, a molded resin body molded from a liquid crystal polymer (LCP).

As illustrated in FIGS. 2 and 3, the power receiving coil 20 is provided on a lower surface of the power-receiving coil holder 22 (As previously described, in FIG. 2, a side where a power receiving coil 20 on the surface of the power-receiving coil device 23 is visible is shown as an upper surface.) The power receiving coil 20 in FIG. 2 includes the following power receiving coils illustrated in FIG. 3: a power receiving coil 20C in the power-receiving-side rising portion CS, and a power receiving coil 20F in the planar portion CC1. The power receiving coil 20C and the power receiving coil 20F are continuous with each other rather than being separate from each other. The power receiving coil 20C is a spiral conductor pattern extending along a spherical surface, and the power receiving coil 20F is a spiral conductor pattern extending along a planar face. The power receiving coil 20 is, for example, a conductor pattern of Cu patterned as described above.

The upper portion of FIG. 3 is a longitudinal sectional view illustrating a state before the power-receiving coil device 23 is attached to the power-receiving coil device holder 24. The lower portion of FIG. 3 is a longitudinal sectional view illustrating a state in which the power-receiving coil device 23 is attached to the power-receiving coil device holder 24.

The power-receiving coil device holder 24 has a shape defining a portion of a sphere (spherical shell) that has a predetermined thickness (a spherical cap having a predetermined thickness). As illustrated in FIG. 3, the inner surface of the power-receiving coil device holder 24 has a curvature the same or substantially the same as the curvature of the outer surface of the power-receiving-side rising portion CS of the power-receiving coil holder 22. As the outer surface of the power-receiving-side rising portion CS of the power-receiving coil holder 22 is held in contact with the inner surface of the power-receiving coil device holder 24, the power-receiving coil device holder 24 holds the power-receiving coil holder 22. The power-receiving coil device holder 24 is, for example, a molded resin body molded from resin such as ABS resin, acrylic resin, or polycarbonate.

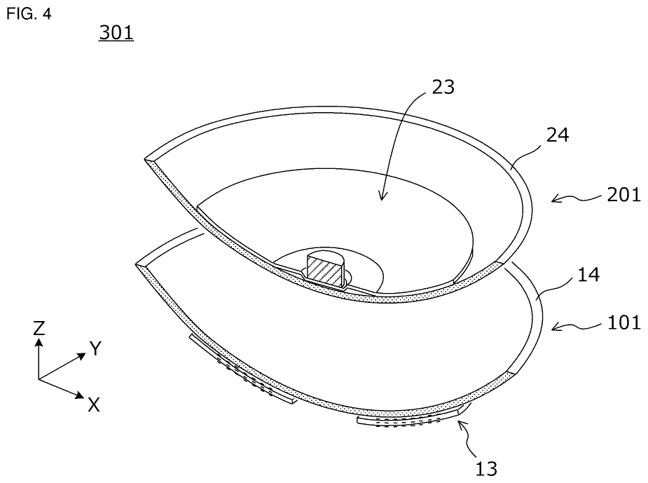

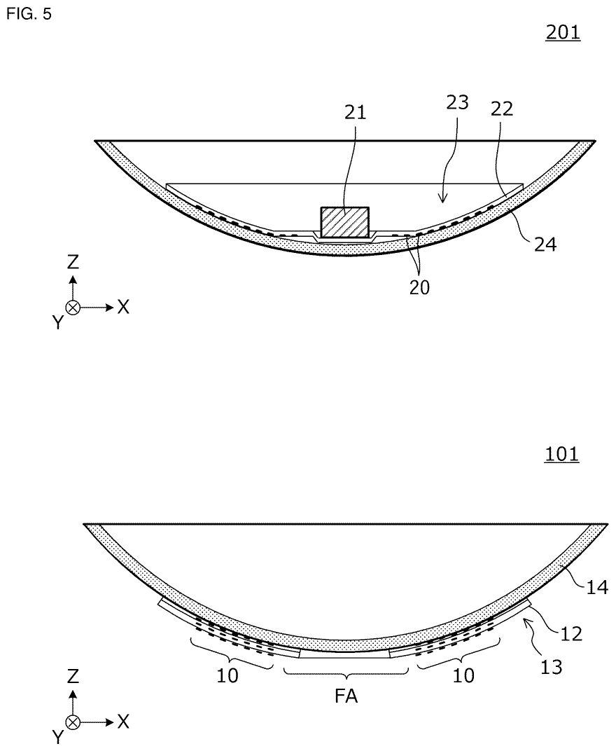

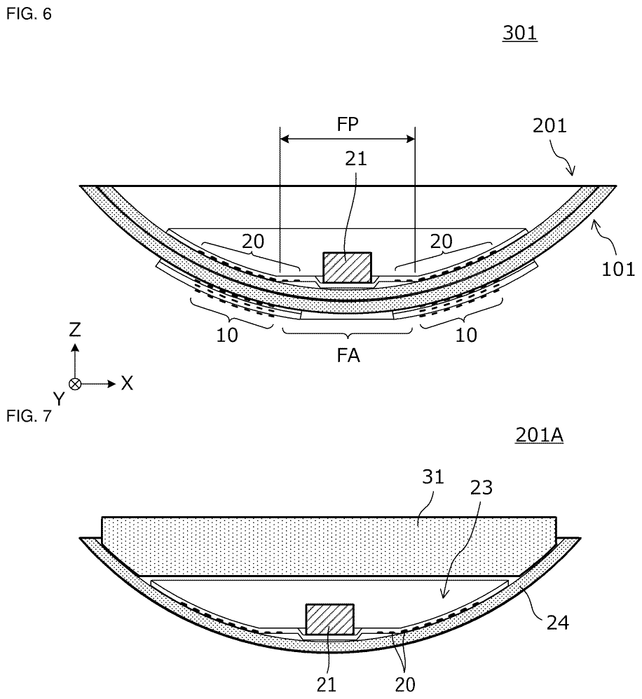

FIG. 4 is a partially cutaway perspective view of a power transfer system 301 according to the first example embodiment of the present invention, which includes the power feeder 101 and the power receiver 201. FIG. 5 illustrates, in longitudinal section, the power receiver 201 and the power feeder 101. FIG. 6 is a longitudinal sectional view of the power transfer system 301 with the power receiver 201 provided on the power feeder 101.

The power feeder 101 includes a power-feeding coil device 13, and a power-feeding-side housing 14. The power feeder 101 includes components (not illustrated) other than those described above.

A power feeding coil 10 is provided (disposed) on a power-feeding coil holder 12. The power feeding coil 10 is a multilayer coil that extends around a coil opening (opening through which magnetic flux passes in a concentrated manner) FA and that is provided in a plurality of resin layers.

As illustrated in FIG. 6, as seen in the direction (Z-direction) perpendicular or substantially perpendicular to the planar portion FP with the power receiver 201 positioned on the power feeder 101, the power feeding coil 10 and the power receiving coil 20 are disposed at a position where the power feeding coil 10 and the power receiving coil 20 overlap. As seen in the Z-direction, the magnetic component 21 is disposed at a position where the coil opening FA of the power feeding coil 10 and the coil opening of the power receiving coil 20 overlap.

For example, a rectifying and smoothing circuit is connected to the power receiving coil 20, and direct-current output power from the rectifying and smoothing circuit is supplied to a load. For example, a secondary battery is charged by the output power from the rectifying and smoothing circuit. The secondary battery defines and functions as a power source for an electronic circuit.

In the state in FIG. 6, the magnetic component 21 defines and functions as a magnetic path due to the high magnetic permeability of each of the power feeding coil 10 and the power receiving coil 20. This allows for an increased magnetic coupling coefficient between the power feeding coil 10 and the power receiving coil 20.

As illustrated in FIGS. 5 and 6, the curvature of the inner surface of the power-feeding-side housing 14, and the curvature of the outer surface of the power-receiving coil device holder 24 are equal or substantially equal to each other. Positioning the power receiver 201 on the power feeder 101 such that the outer surface of the power-receiving coil device holder 24 contacts the inner surface of the power-feeding-side housing 14 makes it easy to maintain the relative positional relationship between the power feeder 101 and the power receiver 201. This also maintains the magnetic coupling coefficient between the power feeding coil 10 and the power receiving coil 20 in a stable manner.

According to the present example embodiment, as illustrated in FIGS. 3 and 6, the planar portion FP includes the recess CC therein. The recess CC is defined by the first planar portion CC1, which is located at the height Hc where the power-receiving-side rising portion CS and the planar portion FP are continuous with each other, and by the second planar portion CC2 located at a lower height than the first planar portion CC1. This configuration provides advantageous effects described below. First, providing the magnetic component 21 in the recess CC makes it possible to lower the height of the upper surface of the magnetic component 21, and thus increase the space above the magnetic component 21. Further, the magnetic component 21 can be positioned closer to the position located midway between the coil opening of the power feeding coil 10 and the coil opening FA of the power receiving coil 20. This makes it possible to easily increase the magnetic coupling coefficient between the power feeding coil 10 and the power receiving coil 20.

FIG. 7 is a longitudinal sectional view of a power receiver 201A according to an example embodiment of the present invention. The power receiver 201A includes a secondary battery 31. The secondary battery 31 is disposed above the power-receiving coil device 23. The secondary battery 31 is positioned to cover or block a portion or the entirety of the opening of the power-receiving coil device holder 24.

For example, with the power receiver 201A provided on the power feeder 101 as illustrated in FIG. 6, the secondary battery 31 is charged as previously described.

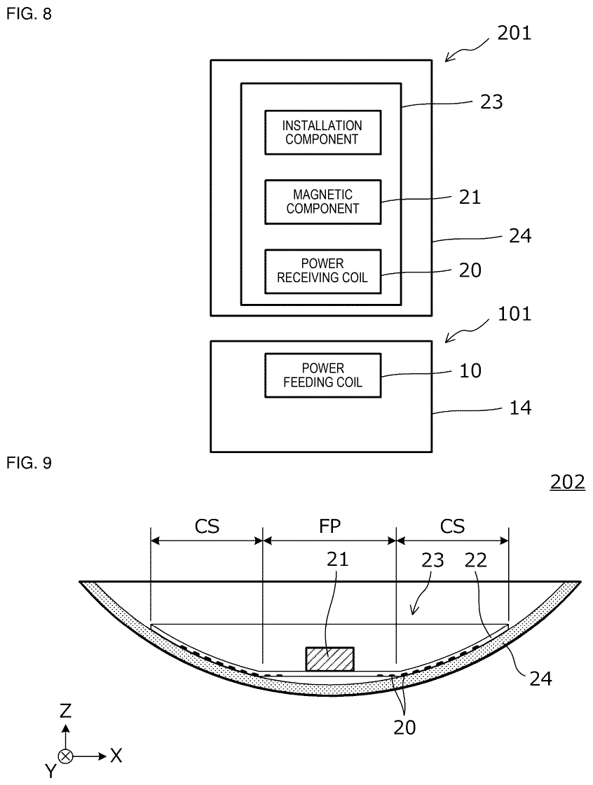

FIG. 8 is a block diagram illustrating the configuration of various portions of the power transfer system according to the first example embodiment. At least the power feeding coil 10 is disposed at the power-feeding-side housing 14 of the power feeder 101. The power-receiving coil device 23 including the power receiving coil 20 and the magnetic component 21 is disposed on the power-receiving coil device holder 24 of the power receiver 201. Examples of installation components to be installed in the power-receiving coil device 23 include various components of the secondary battery 31 illustrated in FIG. 7, the rectifying and smoothing circuit, and a biological detection circuit based on a biological sensor that will be described later.

A second example embodiment of the present invention is directed to a power receiver in which the power-receiving coil holder 22 differs in shape from that according to the first example embodiment.

FIG. 9 is a longitudinal sectional view of a power receiver 202 according to the second example embodiment. The power-receiving coil holder 22 includes the planar portion FP, and the power-receiving-side rising portion CS that extends from the periphery of the planar portion FP and that has a directional (Z-direction) component perpendicular or substantially perpendicular to the planar portion FP and a directional (X-direction) component aligned with the planar portion FP. The magnetic component 21 is bonded to the top central portion of the planar portion FP.

The power-receiving coil device holder 24 is the same or substantially the same as that in the example illustrated in FIG. 3. The inner surface of the power-receiving coil device holder 24 has a curvature equal or substantially equal to the curvature of the outer surface of the power-receiving-side rising portion CS of the power-receiving coil holder 22. As the outer surface of the power-receiving-side rising portion CS of the power-receiving coil holder 22 is held in contact with the inner surface of the power-receiving coil device holder 24, the power-receiving coil device holder 24 holds the power-receiving coil holder 22.

As with the present example embodiment, the power-receiving coil holder 22 need not necessarily include a recess, such as the recess CC illustrated in FIG. 3.

A third example embodiment of the present invention is directed to an exemplary configuration in which the shape of the power-receiving coil device holder, the holding structure for the magnetic component, and the installation component differ from those according to the examples described above with reference to the first and second example embodiments.

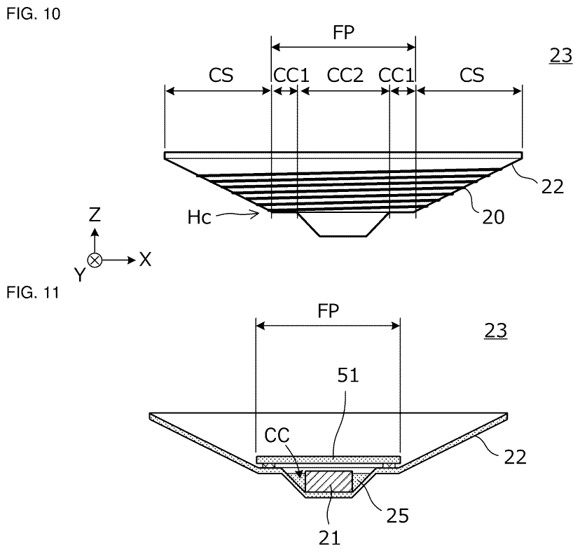

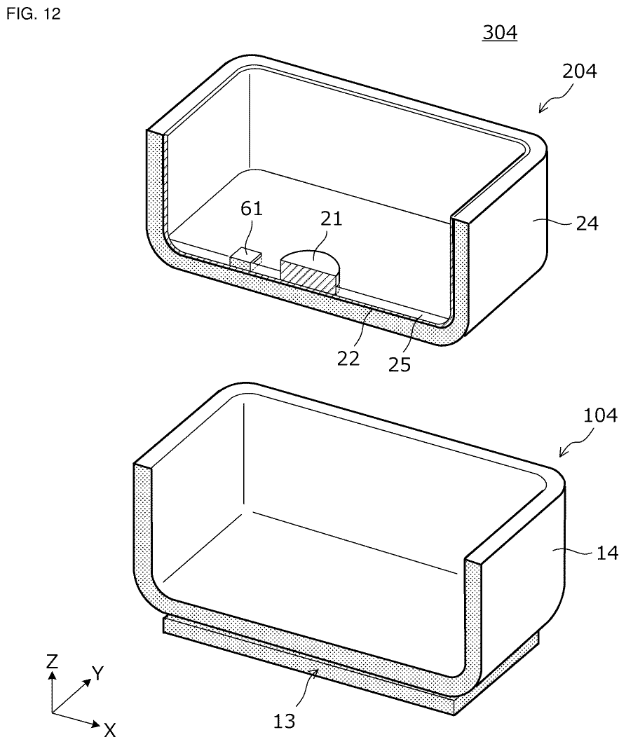

FIG. 10 is a front view of the power-receiving coil device 23 according to the third example embodiment. FIG. 11 is a front sectional view of the power-receiving coil device 23. The power-receiving coil device 23 includes the power-receiving coil holder 22, and the power receiving coil 20 provided on the outer surface of the power-receiving coil holder 22.

The power-receiving coil holder 22 includes the planar portion FP, and the power-receiving-side rising portion CS. The planar portion FP defines an X-Y plane. The power-receiving-side rising portion CS extends from the periphery of the planar portion FP, and has a directional (Z-direction) component perpendicular or substantially perpendicular to the planar portion FP and a directional (X-direction) component aligned with the planar portion FP. In the present example embodiment, the planar portion FP includes the recess CC therein. The recess CC is defined by the first planar portion CC1 and the second planar portion CC2. The first planar portion CC1 is located at the height Hc where the power-receiving-side rising portion CS and the planar portion FP are continuous with each other. The second planar portion CC2 is located at a lower height than the first planar portion CC1.

The power-receiving-side rising portion CS of the power-receiving coil holder 22 has a shape defining a lateral surface of a circular truncated cone that has a predetermined thickness. The power receiving coil 20 is a coil of a conductor pattern having a conical and spiral shape and provided on the outer surface of the power-receiving-side rising portion CS of the power-receiving coil holder 22. As a conductor other than the power receiving coil, a wiring conductor is also provided at the power-receiving coil holder 22.

As illustrated in FIG. 11, the recess CC is filled (potted) with a protective resin 25. The magnetic component 21 is secured within the recess CC of the power-receiving coil holder 22 by the protective resin 25.

As illustrated in FIG. 11, a circuit board 51 is provided at the planar portion FP. The circuit board 51 is, for example, a multilayer epoxy substrate or a multilayer silicone substrate. The circuit board 51 is electrically/mechanically connected to an electrode provided at the power-receiving coil holder 22. For example, the circuit board 51 is connected by soldering or via a connector.

As with the examples described above with reference to the first and second example embodiments, the power-receiving coil device 23 is held by the power-receiving coil device holder. A portion of the power-receiving coil device holder with which the outer surface of the power-receiving coil holder 22 comes into contact has the shape of a circular truncated cone.

A fourth example embodiment of the present invention is directed to an exemplary configuration in which features such as the shape of the power-receiving coil device holder and the holding structure for the magnetic component differ from those according to the examples described above with reference to the first and second example embodiments.

FIG. 12 is a partially cutaway perspective view of a power transfer system 304 according to the fourth example embodiment, which includes a power feeder 104 and a power receiver 204. The power feeder 104 includes at least the power-feeding coil device 13 and the power-feeding-side housing 14. The power receiver 204 includes at least the power-receiving coil device holder 24, the power-receiving coil holder 22, the magnetic component 21, a mounting component 61, and the protective resin 25.

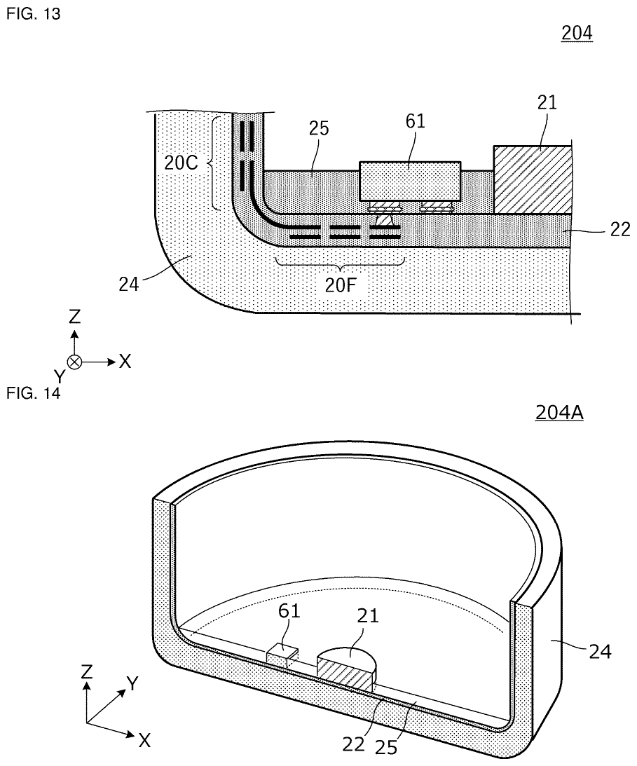

FIG. 13 is a partial front sectional view of the power receiver 204. The power receiving coil 20F extending in the X-Y plane, and the power receiving coil 20C extending in the Y-Z plane and the X-Z plane are provided inside the power-receiving coil holder 22. The power receiving coils 20C and 20F are connected via a portion that extends between the Y-Z plane and the X-Z plane while changing its orientation. The power receiving coils 20C and 20F thus define an integral power receiving coil. That is, as a whole, the power receiving coils 20C and 20F are located in the periphery of the bottom surface portion of the power-receiving coil holder 22 (i.e., at a position spaced away from the magnetic component 21) and in the lower portion of the lateral surface of the power-receiving coil holder 22.

The protective resin 25 is provided on the inner bottom surface of the power-receiving coil holder 22. The protective resin 25 is configured to solidify in order to secure the magnetic component 21 and the mounting component 61 onto the inner bottom surface of the power-receiving coil holder 22.

The power receiver 204 is formed as the power-receiving coil holder 22 is inserted and fit inside the power-receiving coil device holder 24.

A conductor pattern that loops around in the X-Y plane is provided inside the power-feeding coil device 13.

The power-feeding-side housing 14 is open at its upper surface. The inner surface of the power-feeding-side housing 14 is shaped and dimensioned to allow the outer surface of the power-receiving coil device holder 24 to be inserted in very close proximity to the inner surface of the power-feeding-side housing 14.

With the power-receiving coil device holder 24 inserted inside the power-feeding-side housing 14, that is, with the power receiver 204 positioned on the power feeder 104, the power feeding coil in the power-feeding-side housing 14 is magnetically coupled with the power receiving coils 20F and 20C in the power-receiving coil device holder 24.

The power feeding coil may also be provided in a lateral surface of the power-feeding-side housing 14 (one or both of the lateral surface extending in the X-Z plane and the lateral face extending in the Y-Z plane). The power-feeding coil device 13 may be configured as an integral power feeding coil such that a pattern extending in the X-Z plane and/or a pattern extending in the Y-Z plane are connected in series with a pattern extending in the X-Y plane.

FIG. 14 is a partially cutaway perspective view of a power receiver 204A according to the fourth example embodiment. With the power receiver 204 in FIG. 12, the power-receiving coil holder 22 and the power-receiving coil device holder 24 have the shape of a rectangular or substantially rectangular tube that is closed at one end. With the power receiver 204A in FIG. 14, the power-receiving coil holder 22 and the power-receiving coil device holder 24 have the shape of a cylinder that is closed at one end.

A power receiving coil extending in the X-Y plane, and a power receiving coil extending in the Y-Z plane and the X-Z plane are provided continuously inside the power-receiving coil holder 22.

Although not illustrated in FIG. 14, the power-feeding-side housing of the power feeder similarly has the shape of a cylinder that is closed at one end. As with the example in FIG. 12, with the power-receiving coil device holder 24 inserted inside the power-feeding-side housing, that is, with the power receiver 204A provided on the power feeder, the power feeding coil and the power receiving coil are magnetically coupled.

As described above, the power-receiving coil holder 22 may include the planar portion, and the rising portion extending from the periphery of the planar portion and having the directional component perpendicular or substantially perpendicular to the planar portion and the directional component aligned with the planar portion, and may be cylindrical in shape. According to the present example embodiment, the rising portion is short, and the planar portion can have an increased size. This makes it possible to reduce or prevent an increase in area that may result from mounting of a mounting component.

A fifth example embodiment of the present invention is directed to an example of how a power receiving coil is provided in or on the power-receiving coil holder.

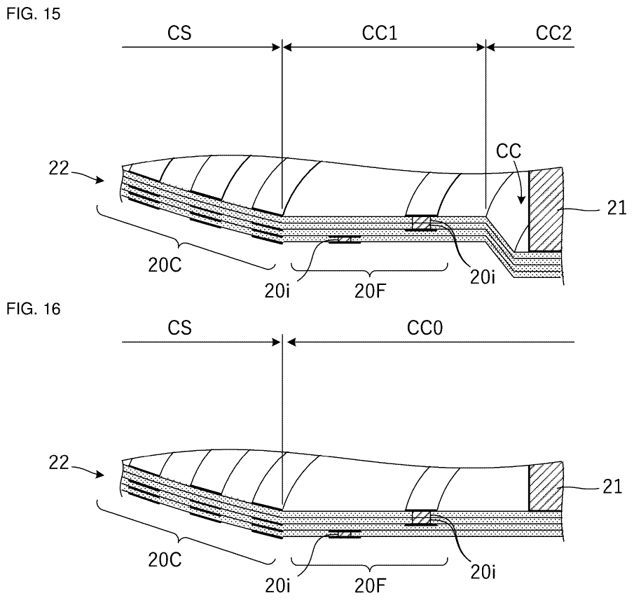

FIGS. 15 and 16 are partial perspective views of the power-receiving coil holder 22 of the power receiver according to the fifth example embodiment. FIG. 15 illustrates an example with the recess CC provided in the planar portion. FIG. 16 illustrates an example with no recess CC.

In these example embodiments, the power-receiving coil holder 22 includes a multilayer substrate including a stack of four resin layers. The power receiving coil 20C is provided at the power-receiving-side rising portion CS of the power-receiving coil holder 22, and the power receiving coil 20F is provided at the planar portions CC0 and CC1 of the power-receiving coil holder 22.

Each resin layer is made of, for example, a thermoplastic resin such as a liquid crystal polymer (LCP). In the present example embodiment, the power-receiving coil holder 22 is a multilayer body produced by thermal pressing of the four thermoplastic resin layers against a mold so that the respective thermoplastic resins of the resin layers self-adhere to each other.

In the present example embodiment, conductor patterns for the power receiving coils 20C and 20F are provided at the resin layers, and the power receiving coils at different layers are interconnected via an interlayer connection conductor 20i. The interlayer connection conductor 20i is provided in the planar portion of the power-receiving coil holder. This configuration stabilizes the heating temperature and the pressure applied to the interlayer connection conductor during pressing, and thus provides the interlayer connection conductor 20i that is electrically and mechanically stable.

In the present example embodiment, a coil conductor pattern is provided on each outer surface of the power-receiving coil holder 22. The presence of a coil pattern on each of the front and back layers makes it possible to increase the number of winding layers. This configuration also enables improved heat dissipation.

If the power-receiving-side rising portion CS of the power-receiving coil holder 22 has the shape of, for example, a truncated quadrangular pyramid with an inclined planar portion, a component can be provided at the inclined planar portion.

A sixth example embodiment of the present invention is directed to an example of a power-receiving coil holder including a conductor that is disposed at the power-receiving coil holder and that is different from the power receiving coil.

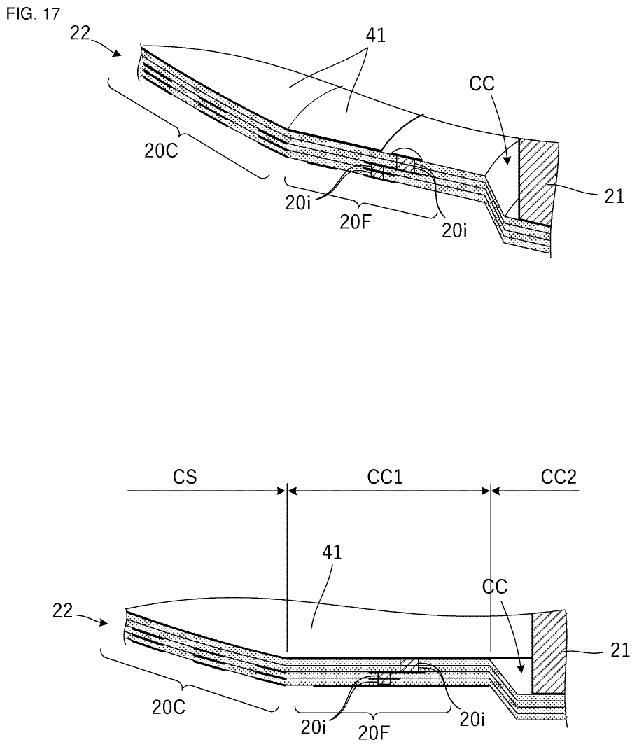

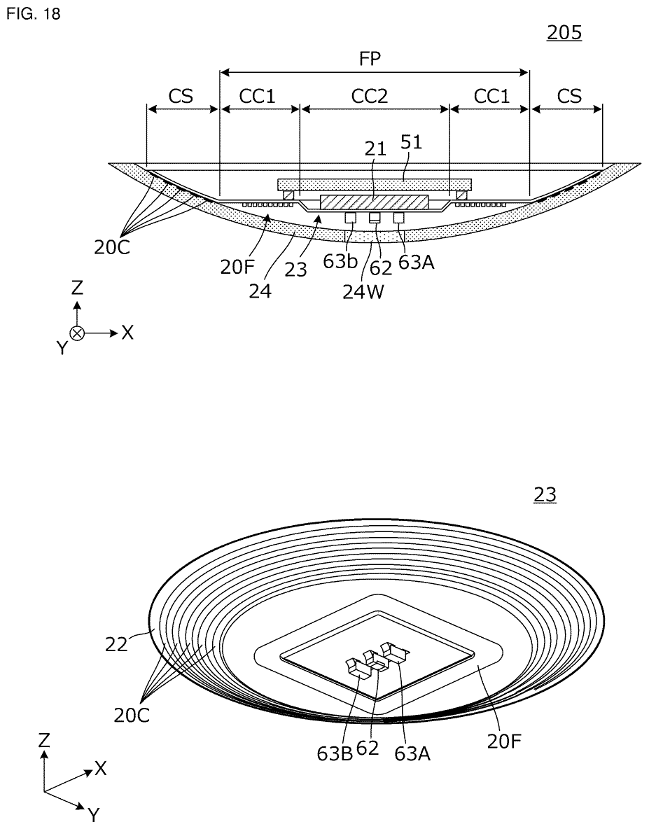

The upper portion of FIG. 17 is a partial sectional perspective view of the power-receiving coil holder 22 of a power receiver according to the sixth example embodiment. The lower portion of FIG. 17 is a partial front sectional view of the power-receiving coil holder 22.

The power-receiving coil holder 22 includes a multilayer substrate including a stack of four resin layers. The power receiving coils 20C and 20F are provided at the lower three layers of the four resin layers. A shield conductor 41 is provided at the uppermost one of the four resin layers.

Features other than those described above are the same or substantially the same as those of the power-receiving coil holder according to the fifth example embodiment illustrated in FIG. 15. According to the present example embodiment, the shield conductor 41 shields a component provided at the power-receiving coil holder, a wiring conductor, and a circuit defined by the component and the wiring conductor. This provides improved shielding for the power receiver. Further, the shield conductor 41 is separated from the power receiving coils 20C and 20F by a plurality of (two in the present example) layers. This configuration helps to avoid a reduction of electromagnetic coupling between the power receiving coil and the power feeding coil. This configuration also helps to reduce generation of an eddy current in the shield conductor 41, leading to lower power loss.

A seventh example embodiment of the present invention is directed to a configuration in which the power-receiving coil device 23 and the power-receiving coil device holder 24 differ in construction from those described in the foregoing description.

FIG. 18 is a longitudinal sectional view of a power receiver 205. The lower portion of FIG. 18 is a perspective view of the power-receiving coil device 23 as seen from below.

The power receiving coil 20C is provided on the lower surface of the power-receiving-side rising portion CS of the power-receiving coil device 23. The power receiving coil 20F is provided on the lower surface of the planar portion CC1 of the power-receiving coil device 23.

A light emitting element 62 and light receiving elements 63A and 63B are provided on the planar portion CC2 of the power-receiving coil device 23. In particular, in the present example embodiment, the light emitting element 62 and the light receiving elements 63A and 63B are provided on the lower surface of the planar portion CC2 of the power-receiving coil device 23, that is, on a surface that, as seen from the second planar portion CC2, is located in a direction opposite from the direction (Z-direction) of the opening of the power-receiving coil device 23. The magnetic component 21 is provided on the upper surface of the second planar portion CC2 of the power-receiving coil device 23.

As illustrated in the upper portion of FIG. 18, the power-receiving coil device holder 24 includes an optical window 24W in a portion thereof. With the power-receiving coil device 23 fit inside the power-receiving coil device holder 24, the optical window 24W defines and functions as an optical window for the light emitting element 62 and the light receiving elements 63A and 63B.

The circuit board 51 is provided at the planar portion FP. The light emitting element 62 and the light receiving elements 63A and 63B are connected to the circuit board 51. The circuit board 51 includes a processor to process information detected by a biological sensor.

Due to the configuration described above, the power receiver 205 defines and functions as, for example, a biological sensor that uses an optical signal.

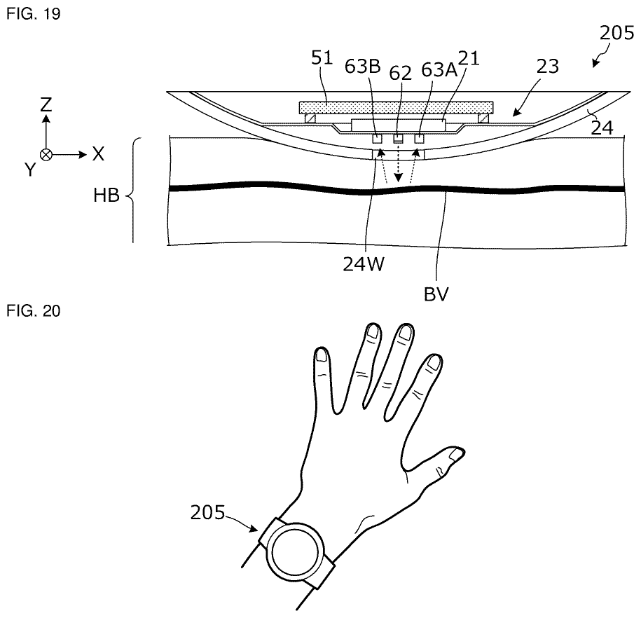

FIG. 19 is a sectional view of the power receiver 205 that is being used as a biological sensor for a biological body HB. In FIG. 19, for clarity of illustration of various portions, the hatching to be applied to cross-sections of these portions is omitted. As illustrated, the power receiver 205 is used with the projecting portion of the power-receiving coil device holder 24 facing toward the biological body. Light emitted from the light emitting element 62 impinges on a blood vessel BV within the biological body HB, and a portion of the reflection is received by one or both of the light receiving elements 63A and 63B.

FIG. 20 illustrates the power receiver 205 that is being worn on the left wrist of a human body. With the power receiver 205 in the state in FIG. 20, the projecting portion of the power-receiving coil device holder 24 is in contact with the biological body as illustrated in FIG. 19. In the state in FIG. 20, for example, pulse rate or blood oxygen concentration is measured, and the measurement is transmitted by radio via, for example, an antenna.

The present invention is not limited to the above-described example embodiments. Various modifications and variations can be made to the example embodiments as appropriate by persons skilled in the art. The scope of the present invention is defined not by the above-described example embodiments but by the appended claims. Further, the scope of the present invention is intended to cover all modifications and variations that may fall within the scope of the appended claims and their equivalents.

For example, in FIGS. 15, 16, and 17, the power receiving coils 20C and 20F provided over a plurality of layers are positioned to overlap as seen in the direction of stacking of the layers. Alternatively, however, the power receiving coils 20C and 20F may be positioned such that, as seen in the direction of stacking, the power receiving coils 20C and 20F do not completely overlap or do not overlap at all. For example, the power receiving coils 20C and 20F may be positioned in a staggered arrangement.

Although FIGS. 1 to 6 illustrate an example embodiment in which the magnetic component 21 is mounted on the planar portion FP of the power-receiving coil holder 22, a mounting component to be mounted to the power receiver is not limited to the magnetic component 21.

A mounting component such as the magnetic component 21 may be mounted to, for example, the power receiver 201 such that the mounting component extends beyond the planar portion FP of the power-receiving coil holder 22 to a position outside the planar portion FP.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power receiver configured to be positioned in proximity to a power feeder to receive electric power, the power feeder including a power-feeding-side housing and a power feeding coil, the power-feeding-side housing including a power-feeding-side rising portion, the power feeding coil being provided at the power-feeding-side housing, the power receiver comprising:
a power-receiving coil holder extending along and in proximity to the power-feeding-side housing; and
a power receiving coil and a conductor other than the power receiving coil, the power receiving coil and the conductor other than the power receiving coil being located in the power-receiving coil holder or extending along a surface of the power-receiving coil holder; wherein
the power-receiving coil holder includes:
a planar portion; and
a power-receiving-side rising portion extending from a periphery of the planar portion and along the power feeding-side rising portion, the power-receiving-side rising portion including surfaces oriented in different directions;
the power receiving coil is located along the planar portion and the power-receiving-side rising portion; and
at least one of the power feeding coil and the power receiving coil is located on a plurality of layers of a laminated substrate.

2. The power receiver according to claim 1, further comprising a mounting component mounted inside a coil opening of the power receiving coil and on the planar portion of the power-receiving coil holder.

3. The power receiver according to claim 2, wherein the mounting component includes a magnetic component including a magnetic material or a magnetic body.

4. The power receiver according to claim 3, wherein
the planar portion of the power-receiving coil holder includes a plurality of planar portions located at different heights in a direction perpendicular or substantially perpendicular to the planar portion; and
the mounting component is mounted in a recess defined by a first planar portion and a second planar portion, the first planar portion being located at a height where the power-receiving-side rising portion and the planar portion are continuous with each other, the second planar portion being located at a lower height than the first planar portion.

5. The power receiver according to claim 4, further comprising a filling resin to secure a component mounted in the recess.

6. The power receiver according to claim 1, further comprising a secondary battery configured to be charged by electric power received by the power receiving coil that, when coupled to the power feeding coil, receives electric power from the power feeding coil.

7. The power receiver according to claim 1, wherein the power-receiving-side rising portion has a shape defining a portion of a sphere that has a predetermined thickness.

8. The power receiver according to claim 1, wherein the power-receiving-side rising portion has a shape defining a lateral surface of a circular truncated cone that has a predetermined thickness.

9. The power receiver according to claim 1, wherein the power-receiving-side rising portion has a tubular shape.

10. The power receiver according to claim 1, further comprising:
a circuit board located at the planar portion; wherein
the power receiving coil is connected to the circuit board.

11. The power receiver according to claim 1, further comprising a biological sensor located at the planar portion of the power-receiving coil holder.

12. The power receiver according to claim 1, further comprising:
a biological sensor located at the planar portion of the power-receiving coil holder; and
a circuit board including a processor configured or programmed to process information detected by the biological sensor.

13. The power receiver according to claim 1, wherein the power-receiving coil holder includes a plurality of resin layers self-adhering to each other and each including thermoplastic resin.

14. The power receiver according to claim 1, wherein the conductor other than the power receiving coil includes a shield conductor covering the planar portion and the power-receiving-side rising portion, or covering the planar portion or the power-receiving-side rising portion.

15. A power transfer system comprising:
the power receiver according to claim 1; and
the power feeder.

16. The power transfer system according to claim 15, further comprising a mounting component mounted inside a coil opening of the power receiving coil and on the planar portion of the power-receiving coil holder.

17. The power transfer system according to claim 16, wherein the mounting component includes a magnetic component including a magnetic material or a magnetic body.

18. The power transfer system according to claim 17, wherein
the planar portion of the power-receiving coil holder includes a plurality of planar portions located at different heights in a direction perpendicular or substantially perpendicular to the planar portion; and
the mounting component is mounted in a recess defined by a first planar portion and a second planar portion, the first planar portion being located at a height where the power-receiving-side rising portion and the planar portion are continuous with each other, the second planar portion being located at a lower height than the first planar portion.

19. The power transfer system according to claim 18, further comprising a filling resin to secure a component mounted in the recess.

20. The power transfer system according to claim 15, further comprising a secondary battery configured to be charged by electric power received by the power receiving coil that, when coupled to the power feeding coil, receives electric power from the power feeding coil.
